(19) United States
(12) Patent Application Publication
(10) Pub. No.: US 2006/0081507 A1
(43) Pub. Date: Apr. 20, 2006

(54) Apparatus for the electrostatic separation of particulate mixtures

(76) Inventor: Peter Gates, Worongary (AU)

Correspondence Address: MOORE & VAN ALLEN PLLC, P.O. BOX 13706, Research Triangle Park, NC, 27709, US

(21) Appl. No.: 11/246,416

(22) Filed: Oct. 7, 2005

(30) Foreign Application Priority Data
Oct. 11, 2004 (AU) 2004905823

(51) Int. Cl. B03C 7/00

(52) U.S. Cl. 209/127.1; 209/127.2; 209/128

(57) ABSTRACT

An apparatus for the electrostatic separation of a mixture of particles that exhibit difference in electrical conductivity comprising: a rotating roll with a conductive surface to which conducting particles lose their charge; feeding means for feeding the mixture of particles onto the conductive surface; an ionising electrode for ionising individual particles in the mixture of particles; a first static electrode having the same polarity as the ionising electrode and which serves to generate a static electric field, the first static electrode being located sufficiently close to the ionising electrode that the static field acts on the particles immediately after they are ionised; and splitter comprising a leading edge over which a conductor fraction stream flung from the rotating roll following charge decay in these particles passes, wherein the leading edge of the splitter is positioned beneath the first static electrode so that the conductor fraction remains under the influence of the static electric field as it is collected.

### TECHNICAL FIELD

The present invention is concerned with a particle separator for the separation of particulate mixtures comprising species that exhibit difference in electrical conductivity and, more particularly, with the separation of particulate mixtures comprising species that exhibit difference in electrical conductivity through electrostatic separation.

### BACKGROUND ART

Mineral separation plants used in the titanium mineral processing industry world-wide consist essentially of similar process technologies applied in a manner that is often tailored to the separation requirements of or an individual ore body. Dependent upon a wide number of factors including particle size and shape, mineral grade, geology of the ore body, type of mineral species present and the physical characteristics of said mineral species, a unique recovery process is applied to optimise plant performance and satisfy operational and capital cost targets. Nevertheless, all titanium mineral processing plants in the world utilise similar process technologies applied in varying ways to accomplish their process needs.

Mining is carried out by firstly excavating the ore and subjecting it to gravity concentration, which isolates the heaviest particles into what is termed a heavy mineral concentrate. The heavy mineral concentrates are sent to a dry separation plant, where individual minerals species (of which there may up to 20 or more present) are separated using their different magnetic, electrical or other physical properties, often at elevated temperatures. Separation equipment commonly includes but is not limited to, high-tension electrostatic roll (HTR) and electrostatic plate (ESP) separators, as well as gravity and magnetic processes. Using electrostatic separation techniques the conductors such as rutile and ilmenite are separated from the non-conductors such as zircon, quartz and monazite. These separators are extensively used for the separation of conductor and non-conductor mineral species typically found in the titanium minerals industry.

Based on the charging mechanisms employed, three basic types of “electrostatic” separators include; (1) high tension roll ionised field separators (HTR), (2) electrostatic plate and screen static field separators (ESP and ESS herein called ESP) and (3) triboelectric separators. ESP and HTR separators are the most commonly used in the titanium minerals industry.

Customarily, HTR separators utilise a grounded roll that transports the feed material through a high voltage ionising field (corona) that charges the particles by ion bombardment. Conducting particles then lose much of their charge to the earthed roll and are thrown from the roll by centrifugal and gravity forces. Non-conducting particles remain pinned to the rotor and are transported further around the roll before their charge either dissipates and they are thrown off or are removed by either mechanical means (brush) or high voltage AC wiper.

The three basic separation principles are often not present alone in any mechanism, and the machine characterisation essentially refers to the predominant or major separating effect. A device known as a Coronastat which relies primarily on ion bombardment to charge the particles but is a substantial advance over existing HTR separators is described in the present inventor's earlier International Patent Application No. PCT/AU01/00917 (WO02/09882).

CoronaStat separators include an ionising wire similar to previous HTR separator which charges the mineral particles and a second static electrode which enhances the natural charge decay of the conducting particles. Accordingly the conducting particles are be thrown off the rotating roll surface due to the centrifugal or gravitational forces, and this takes place more rapidly and effectively than in a conventional HTR separator in view of the enhanced charge decay. Non-conductors being less able to conduct their charge to the grounded surface are pinned to the roll surface.

The CoronaStat device has improved the separation capability over conventional HTR devices, immensely allowing more efficient division of the feed into predominantly conductor and non-conductor rich fractions. However, feed streams where non-conductors are larger than the conductors, feed streams containing very fine conductor particles (for example 50 to 100 microns in size) or feed streams that contained titanium minerals having very low conductivity or electrically resistant coatings may be incompletely separated.

### DISCLOSURE OF THE INVENTION

The present invention provides a means for enhancing both conductor and non-conductor grades simultaneously by increasing the charge decay in conducting particles in the separation zones of the separator and collecting the conductor particles at an earlier point in the separation process, thereby enhancing separation efficiency.

Accordingly, in one aspect of the present invention there is provided an apparatus for the electrostatic separation of a mixture of particles that exhibit difference in electrical conductivity, comprising:

a rotating roll with conductive surface to which conducting particles lose their charge;

feeding means for feeding the mixture of particles onto the conductive surface;

an ionising electrode for ionising individual particles in the mixture of particles;

a first static electrode having the same polarity as the ionising electrode and which serves to generate a static electric field, the first static electrode being located sufficiently close to the ionising electrode that the static electric field acts on the particles immediately after they are ionised; and

a splitter comprising a leading edge over which a conductor fraction stream flung from the rotating roll following charge decay in these particles passes, wherein the leading edge of the splitter is positioned beneath the first static electrode so that the conductor fraction stream remains under the influence of the static electric field as it is collected.

In the similar manner to International Patent Application No. PCT/AU01/00917 the contents of which are incorporated herein by reference, it will be appreciated that the first static electrode ordinarily has its leading edge closely adjacent the ionising electrode, and preferably has its leading edge located behind the ionising electrode with respect to the conductive surface. This ensures that the static electric field generated by the first static electrode acts continuously upon the ionised particles both during and after the ionising process. This, in turn, ensures that there is a repelling action on all particles, both conductors and non-conductors tending to force them back onto the roll surface. Accordingly, particle bounce is minimised and particle contact with the conductive roll surface is maximised. As a result, prior to the conductor stream off take, the maximum decay of charge on the conducting particles is provided.

In an embodiment the first static electrode extends down and outward from the roll to a position past the conductor stream off take splitter, ensuring that all particles are under the full influence of the first static electrode over the entire zone where conductors are removed. The influence of the static electrode provides not only charge decay of the conductor particles but repulsion of the charged non-conductor particles. Removing the conductor fraction at a position of full influence of the repulsion effect of the static electrode greatly improves the grade of the conductor fraction.

This repulsion effect is most pronounced with the larger and heavier non-conductors since these are most likely to bounce off the conductive surface and consequently misreport to the conductor stream. However, since these non-conductive particles still carry most or all of the charge attained when ionised they are continuously repelled by the first static electrode and therefore substantially less likely to report to the conductor stream.

It will be appreciated that not all the conducting particles undergo sufficient charge decay to report to the conductor stream. Those that do are referred to hereinafter as the “super conductor” fraction and the elongated splitter “super conductor” splitter.

It will be appreciated that the first static electrode acts upon the particles immediately after they are ionised, and preferably will be of sufficient length to continue to act on particles in the vicinity of the leading edge of the super-conductor splitter.

Since the first static electrode has the same polarity as the ionising electrode its presence both enhances the charge decay of the conductor particles and at the same time repels non-conductors from the super-conductor fraction.

In an embodiment the static electric field generated by the first static electrode acts on the conductive surface at a point beyond where the “super conductor” splitter is positioned to continue to hold the non-conducting particles onto the conductive surface. In this regard, the super conductor splitter is made from an electrically insulating material allowing the electric field generated by the first static electrode to be continuous between itself and the roll in the area under the super-conductor splitter blade.

In particular, very large or heavy particles are maintained on the conductive surface in this fashion. This ensures that they remain in contact with the surface for sufficient time to join the non-conductor stream.

In a further embodiment a second static electrode is present in the apparatus. This serves to extend the distance over which the static electric field is applied to the conductive surface. This embodiment of the invention in particular, maximises conductor particle charge decay and minimises sensitivity to particle size variation compared to prior art separators thereby contributing to improved separator performance.

In an embodiment the second static electrode has the same polarity as the ionising electrode but is positioned after the super-conductor splitter off take i.e. further around and sufficiently close to the rotating roll so as to exert a separate static field enabling further substantial charge decay of conducting particles remaining on the roll. The main purpose of this second static electrode is to provide massive charge decay to remaining conducting particles forcing their removal into the mid fraction for re-treatment on subsequent separation stages.

The preferred position of this second static electrode is adjacent to and outward from the three to four o'clock position and installed closer to the roll surface thereby providing greater electric field strength than the first static electrode.

A still further embodiment is to operate the second static electrode at a potential opposite to that of the ionising wire and the first static electrode in order to attract charged particles from the roll surface.

In an embodiment all three electrodes operate at similar polarity. It is also advantageous that a similar voltage is applied to all three electrodes and the electrode spacing from the roll is adjusted to provide optimised field strengths at each point.

In an embodiment the splitter is an elongated baffle which partitions the super conductors from the roll for collection. The baffle is advantageously moveable at its base to allow the position of the leading edge to be adjusted to suit the particulate mixture.

In an alternative embodiment, where a second static electrode is present, the splitter may comprise a plate mounted to the second static electrode. Advantageously the second static electrode is adapted for pivotal motion and the plate will move with the electrode to allow adjustment of the position of its leading edge. The plate will generally direct the super conductors to an appropriate collection device.

A typical roll speed is around 150 to 250 rpm. Separation may also be enhanced by increasing the electrical field strength and typically voltages in the range of 15 to 50 kV may be applied to any of the electrodes in the apparatus. The voltage applied to any of the electrodes may be the same or different.

In the manner described in International Patent Application No. PCT/AU01/00917, one or both of the first and second static electrodes is a dielectric electrode. The use of a dielectric semi-conductor or non-conductor electrode is preferred, but a metal electrode may also be used. It will be appreciated that the dielectric electrode may easily be arranged in very close proximity with the ionising electrode, and the close proximity of the electrode to the roll surface allows higher field strengths to be obtained.

It will also be appreciated that the first or second static electrodes could be finger electrodes as described in International Patent Application No. PCT/AU01/00917. However, such finger electrodes produce an electric field of non-uniform strength across the roll surface. Accordingly electrode may also be used as a continuous plate in the manner described in International Patent Application No. PCT/AU01/00917.

In a manner described in International Patent Application No. PCT/AU01/00917 the separation roll diameter is not critical. Typically the diameter of the roll in the apparatus described above will be between 150 mm and 1000 mm, preferably between 200 and 400 mm.

The present invention also allows for a multi-stage particle separator comprising apparatus as described above in operative association with a further particle separator or separators, which is typically also apparatus as described above.

### BRIEF DESCRIPTION OF THE DRAWINGS

Preferred embodiments of the present invention will now be described, by way of example only, with reference to the accompanying drawings, in which:

FIG. 1 is an elevation showing apparatus in accordance with an embodiment of the present invention; and

FIG. 2 is an elevation showing the apparatus in accordance with an alternative embodiment of the invention.

### MODES FOR CARRYING OUT THE INVENTION

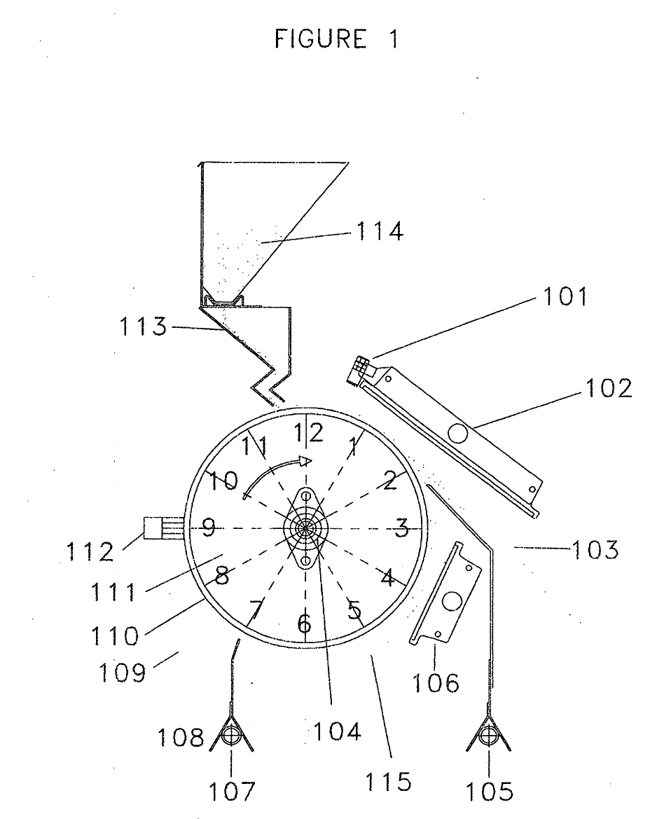

The apparatus shown in FIG. 1 is a particle separator used to separate particulate mixtures comprising species that exhibit difference in electrical conductivity. In particular, the apparatus serves to separate electrically conducting species from non-conducting species on the basis of their differing capacities to retain charge in a roll-type electrostatic separator.

Referring to FIG. 1, a mixture of particulate material is contained within hopper 114 and fed via a feed metering plate through feeding means, in this case a simple chute 113, onto roll 111. The particulate material may also be fed onto the roll by other suitable means such as a roll feeder system. The path followed by the feed material and the configuration of the chute may be varied in order to suit the nature of the feed material and other operating parameters, as would be well understood by the person skilled in the art.

The roll 111 has an exterior surface 110 that is made of a conductive material such as chromium. The roll 111 rotates at a speed of around 150 to 250 rpm and carries with it the particulate mixture as it rotates. The roll 111 bears the numerals 1 to 12 around its diameter, and these numerals indicate (for the sake of clarity) the “o'clock” position by which distance around a circular face of cylindrical surface is generally indicated i.e. the “two o'clock” position is where the number 2 is located. In this instance the roll 111 rotates in the clockwise direction, but it may also rotate in the anti-clockwise direction if desired. The apparatus includes appropriate drive mechanisms and control mechanisms, as would be well understood by the person skilled in the art. The roll diameter is typically 200 mm to 400 mm in the apparatus shown. The roll 111 is mounted for rotation upon axle 104, as would be well understood by the person skilled in the art.

The apparatus 101 includes an ionising electrode comprising a corona wire. The apparatus also includes a first static electrode 102 spaced apart from the exterior surface 110 of the roll 111.

A high voltage power supply is connected to the corona support assembly 101 via a lead. The position of the Corona wire support assembly 101 and the first static electrode 102 may be adjusted either together or independently, resulting in a change in the relative corona and static field strengths. Alternatively, this may done through provision of two or more separate high voltage power supplies, one connected to the corona wire 101 and at least one other connected to the first static electrode 102 and/or second static electrode 106.

As illustrated in FIG. 1, the particulate mixture is fed onto the exterior surface 110 of the roll 111. The particles in the mixture become charged under the influence of the high voltage ionising field emanating from the corona wire. Since the static electrode 102 has the same polarity as the ionising electrode, the electric field generated ensures immediate repulsion of the charged mineral particles by the static electrode that forces the particles onto the exterior surface of the roll. In so doing, particle bounce is greatly reduced as the repulsion force on ionised particle acts immediately and continuously, even during the process of ionisation of the mixture.

Furthermore, the static electrode 102 begins to decay the charge on the conducting particles that are pinned to the roll surface. An electric field is present over a wide arc, extending from the point of ionisation to a point on the roll past the two to three o'clock position. This ensures repulsion of charged non-conductors occurs over a large area of the roll and specifically the area of the roll where conductors are dislodged from the exterior surface and into the super-conductor fraction.

The superconducting splitter, an elongated baffle 105 moveable at its base, is positioned in the region of the two to three o'clock position and outward of the roll surface, to “cut” a superconducting fraction of very high-grade material. The preferred material for this superconducting splitter is a non-conducting/electrically insulating material to allow the electric field produced by static electrode 102 to be impressed through to the roll surface in this vicinity. This further ensures a wider arc of electric field continuity creating greater charge decay and non-conductor repulsion.

The superconducting fraction is represented in FIG. 1 showing a stream 103 of conductors which are thrown off the roll by a combination of centrifugal force and gravity. Meanwhile, a non-conductor/mid-conductor stream 115 is retained upon the exterior surface 110 of the roll 111, travelling past the point at which the superconducting fraction is taken.

A second static electrode 106 is positioned at around the three to four o'clock position and its functional purpose is to provide an intense “charge decay” inducing electric field ensuring the remaining conductor particles are further decayed allowing them to be thrown from the roll surface and into the mid stream 115.

The second static electrode 106 should be positioned in a manner and be short enough in length to ensure that minimal electric field strength is present at around the 5 o'clock to 6.30 position. An area of low or zero electric field in this 5 o'clock to 6.30 position ensures that conductor particles are free to be thrown from the roll. Charge on such particles has largely decayed at this point however some charge may still remain. For this reason it is advantageous that any electric field induced repulsion forces not be present in this lower part of the separation zone thereby allowing particles to be thrown from the roll surface without external hindrance.

Second static electrode 106 as described greatly assists the removal of the remaining conductors from the roll to report into the mid stream 115 allowing the non-conductor stream 109 to be a better grade.

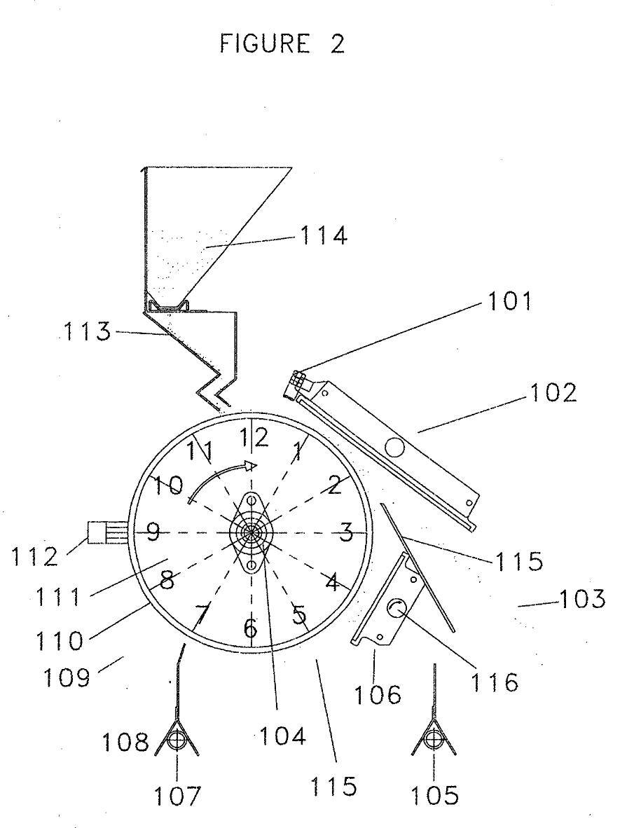

As shown in FIG. 2, a plate 115 mounted to the second static electrode 106 may comprise the splitter. In this case the portion of the leading edge of the plate is adjustable by pivoting the electrode 106 around pivot 116. The super conductors are directed by plate 115 to beyond baffle 105 for collection.

Accordingly, the present invention seeks to simultaneously improve the conductor(super-conductor) and the non-conductor grades which are removed at each process stage. The present invention seeks further to remove a greater middling fraction 115 than prior art separators, re-passing this fraction to subsequent stages in what is known as a “MID” re-treat configuration.

The static electrode 102 and 106 can be metal conducting electrodes or insulated dielectric types such as described in International Patent Application No. PCT/AU00/00223 (WO 00/56462), the contents of which are incorporated herein by reference.

The non-conductors do not easily give up their charge to the grounded exterior surface. Thus, an “image force” strongly pins the non-conductors and poor conductors to the roll although charge decay does occur slowly. Therefore, poor conductors are held on the roll surface 110 until charge decay occurs sufficiently for them to be thrown off. This may be some time after charge decay of the conductors has resulted in these being thrown off.

As shown in FIG. 1, enhanced charge decay provided by electrode 106 improves the likelihood that conductor particles will throw to the mid stream 115. However, the non-conductors remain on the roll until removed there from by conventional means such as a brush 112 which sweeps the non-conductor stream 109 from the roll. The apparatus may also include a roll cleaning device as described in International Patent Application No. PCT/AU01/00917.

### INDUSTRIAL APPLICABILITY

The particle separator of the present invention is useful in separating particles which differ in their electrical conductivity such as in the mineral processing industry. In particular, the invention is useful in titanium mineral process plants. However, many applications exist in areas such as scrap recovery, iron ore or industrial mineral beneficiation processes, whereby this invention can be used to greatly enhance product recovery and grades of material.

1. An apparatus for the electrostatic separation of a mixture of particles that exhibit difference in electrical conductivity comprising:
a rotating roll with a conductive surface to which conducting particles lose their charge;
feeding means for feeding the mixture of particles onto the conductive surface;
an ionising electrode for ionising individual particles in the mixture of particles;
a first static electrode having the same polarity as the ionising electrode and which serves to generate a static electric field, the first static electrode being located sufficiently close to the ionising electrode that the static field acts on the particles immediately after they are ionised; and
a splitter comprising a leading edge over which a conductor fraction stream flung from the rotating roll following charge decay in these particles passes, wherein the leading edge of the splitter is positioned beneath the first static electrode so that the conductor fraction remains under the influence of the static electric field as it is collected.

2. Apparatus as claimed in claim 1 wherein the first static electrode extends downwardly and outwardly from the roll to a position past the splitter.

3. Apparatus as claimed in claim 1 wherein the first static electrode is of sufficient length to continue to act upon the conductor fraction stream to the leading edge of the splitter.

4. Apparatus as claimed in claim 1 wherein the splitter is made from an electrically insulating material.

5. Apparatus as claimed in claim 4 wherein the static electric field continues to act on the conductive surface beyond where the splitter is positioned.

6. Apparatus as claimed in claim 1 wherein the splitter is an elongated baffle which partitions the conductor fraction from the roll.

7. Apparatus as claimed in claim 6 wherein the elongated baffle is moveable at its base to adjust the position of the leading edge.

8. Apparatus as claimed in claim 1 further comprising a second static electrode which serves to extend the distance over which the static electric field is applied to the conductive surface.

9. Apparatus as claimed in claim 8 wherein the second static electrode has the same polarity as the ionising electrode.

10. Apparatus as claimed in claim 8 wherein the second static electrode has the opposite polarity to the ionising electrode.

11. Apparatus as claimed in claim 8 wherein the splitter is an elongated baffle which partitions the conductor fraction from the roll.

12. Apparatus as claimed in claim 11 wherein the elongated baffle is moveable at its base to adjust the position of the leading edge.

13. Apparatus as claimed in claim 8 wherein the splitter is a plate mounted to the second static electrode which directs the conductor fraction away from the roll.

14. Apparatus as claimed in claim 13 wherein the second static electrode is adapted for pivotal motion and the plate moves therewith to adjust the position of the leading edge.

15. Apparatus as claimed in claim 1 further comprising a mineral wiping brush to remove non-conducting particles from the conductive surface.
